(19) United States
(12) Patent Application Publication
(10) Pub. No.: US 2024/0349093 A1
(43) Pub. Date: Oct. 17, 2024

(54) COMMUNICATION METHOD AND COMMUNICATION APPARATUS

(71) Applicant: Beijing Xiaomi Mobile Software Co., Ltd., Beijing (CN)

(72) Inventor: Xiandong DONG, Beijing (CN)

(21) Appl. No.: 18/576,642

(22) PCT Filed: Jul. 7, 2021
(86) PCT No.: PCT/CN2021/104995

§ 371 Date: Jan. 4, 2024

(51) Int. Cl. H04W 24/08; H04W 76/11; H04W 84/12

(52) U.S. Cl. CPC H04W 24/08; H04W 76/11; H04W 84/12

(57) ABSTRACT

A communication method includes: determining a first message frame, the first message frame comprising parameters for configuring a WLAN sensing function; and sending the first message frame.

### CROSS-REFERENCE TO RELATED APPLICATION

The present application is a U.S. National Phase of International Patent Application Serial No. PCT/CN2021/104995, entitled “COMMUNICATION METHOD AND COMMUNICATION DEVICE”, filed on Jul. 7, 2021. The entire contents of the above-cited application are hereby incorporated by reference in their entirety for all purposes.

### BACKGROUND

A wireless local area network (WLAN) features flexibility, mobility, low cost, etc. As the communication technology develops and the users' demand grows, research on the application of the WLAN is being deepened over time.

### SUMMARY

Various examples of the disclosure provide the following technical solutions.

A communication method is provided according to an example of the disclosure. The communication method includes: determining a first message frame, where the first message frame includes a parameter configured to set a wireless local area network (WLAN) sensing function; and sending the first message frame.

A communication method is provided according to an example of the disclosure. The communication method includes: receiving a first message frame, where the first message frame includes a parameter configured to set a wireless local area network (WLAN) sensing function; and executing a communication operation based on the first message frame.

An electronic apparatus is provided according to an example of the disclosure. The electronic apparatus includes a memory, one or more processors, and a computer program stored in the memory and executable in the one or more processors. The one or more processors implements the above method when executing the computer program.

A computer-readable storage medium is provided according to an example of the disclosure. The computer-readable storage medium stores a computer program. The computer program implements the above method when executed by one or more processors.

### BRIEF DESCRIPTION OF THE DRAWINGS

The above and other features of examples of the disclosure will become more apparent by describing examples in detail with reference to the accompanying drawings. In the accompanying drawings:

FIGS. 1(a), (b), and (c) are an illustrative mode of wireless local area network (WLAN) sensing;

FIG. 2 is a flowchart of a communication method according to an example;

FIG. 3 is a flowchart of another communication method according to an example; and

FIG. 4 is a block diagram of a communication apparatus according to an example.

### DETAILED DESCRIPTION

The following description with reference to the accompanying drawings is provided to assist in a comprehensive understanding of various examples of the disclosure as defined by the appended claims and their equivalents. Various examples of the disclosure include various specific details, but these details are to be considered merely illustrative. Further, descriptions of well-known technologies, functions, and configurations may be omitted for clarity and brevity.

The terms and words used in the disclosure are not limited to written meanings, but are used only by the inventors to achieve a clear and consistent understanding of the disclosure. Accordingly, the description of various examples of the disclosure is provided for purposes of illustration only and not for purposes of limitation for those skilled in the art.

It should be understood that, as used here, the singular forms “a”, “an” and “the” may also include the plural forms unless the context clearly indicates otherwise. It should be further understood that the term “include” and “comprise” used in the disclosure specifies the presence of the described features, integers, steps, operations, elements, and/or components, but do not exclude the presence or addition of one or more other features, integers, steps, operations, elements, components, and/or groups of them.

It may be understood that the terms “first”, “second”, etc. are used to describe various elements here, but these elements should not be limited by these terms. These terms are only used to distinguish a first element from another element. Thus, a first element discussed below can also be referred to as a second element without departing from the teachings of the example.

It should be understood that when a component is referred to as being “connected” or “coupled” to another component, it can be directly connected or coupled to the component or intermediate components can also be present. Furthermore, “connected” or “coupled” as used here can denote wireless connection or wireless coupling. As used here, the term “and/or” or the expression “at least one of” includes any and all combinations of one or more of associated listed items.

Unless otherwise defined, all terms (including technical and scientific terms) used here have the same meanings usually understood by those of ordinary skill in the field of the disclosure.

The disclosure relates to the field of wireless communication, in particular to a communication method and a communication apparatus.

A wireless local area network (WLAN) features flexibility, mobility, low cost, etc. As the communication technology develops and the users' demand grows, research on the application of the WLAN is being deepened over time. For example, current research focuses on WLAN sensing, which is chiefly applied to location discovery in dense environments (home and corporate environments), proximity detection, and presence detection.

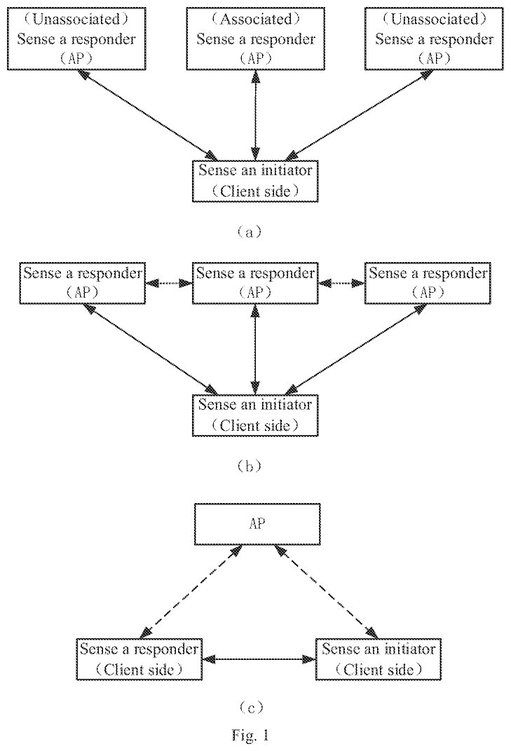

FIGS. 1(a), (b), and (c) are an illustrative mode of wireless local area network (WLAN) sensing.

A WLAN sensing flow may be that an initiator initiates WLAN sensing (for example, initiates a WLAN sensing session), and there may be a plurality of responders responding to the WLAN sensing in possible modes specifically as shown in FIGS. 1(a), (b), and (c).

With reference to FIG. 1(a), when a WLAN sensing initiator (for example, a client) initiates WLAN sensing, a plurality of associated or unassociated WLAN sensing responders (for example, three access points (APs)) may respond. Here, “associated” may mean that an association connection for communication is established between the initiator and the responder. “Unassociated” may mean that no association connection for communication is established between the initiator and the responder.

As an instance, the client may include, but not limited to, a cellular phone, a smart phone, a wearable device, a computer, a personal digital assistants (PDA), a personal communication system (PCS) device, a personal information manager (PIM), a personal navigation device (PND), a global positioning system, a multimedia device, an Internet of Things (IoT) device, etc.

The AP is a wireless switch for a wireless network and is also an access device for Wireless network. The AP may include software applications and/or circuitry, to make other types of nodes in the wireless network communicate with the outside and inside of the wireless network through the AP. As an instance, the AP may be a terminal device or a network device equipped with a wireless fidelity (Wi-Fi) chip.

FIG. 1(b) is similar to FIG. 1(a). In FIG. 1(b), communication between the responders (APs) can be achieved.

With reference to FIG. 1(c), both the WLAN sensing initiator and the WLAN sensing responder may be clients, and may communicate through connection to the same AP.

Although it is shown in FIGS. 1(a), (b), and (c) that the client is the initiator and the AP is the responder, which is not limited to this. For example, the AP may be the initiator and the client may be the responder. Further, the number of initiators and responders is not limited to those shown in FIGS. 1(a), (b), and (c).

A WLAN sensing session initiated by the initiator may include one or more of the following phases: a setup phase, a measurement phase, a reporting phase, and a termination phase.

In the setup phase, the sensing session is established, and operating parameters associated with the sensing session are determined and are exchanged between devices. In the measurement phase, sensing measurement may be executed. In the reporting phase, a sensing measurement result may be reported. In the termination phase, the device stops executing measurement and terminates the sensing session.

In the current research, the lack of definition of parameters used in the above phases is not conducive to WLAN sensing.

In view of this, a communication method and a communication apparatus applied to WLAN sensing are provided according to concepts of examples of the disclosure.

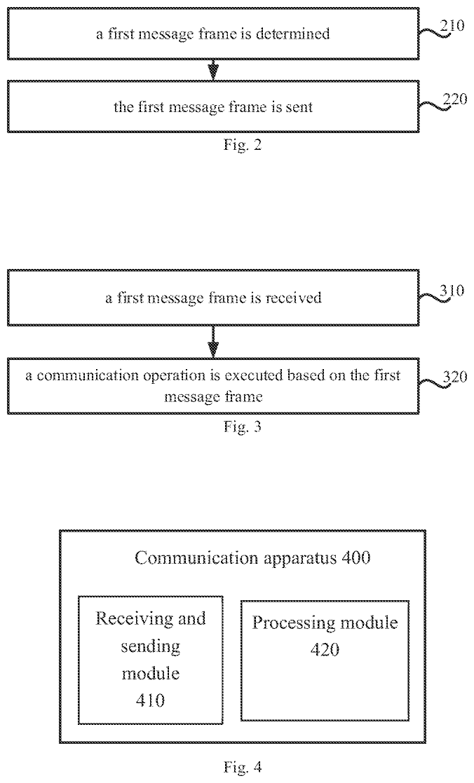

FIG. 2 is a flowchart of a communication method according to an example. The communication method shown in FIG. 2 may be applied to a WLAN sensing initiator.

With reference to FIG. 2, in step 210, a first message frame is determined. According to the example of the disclosure, the first message frame may be, for example, but not limited to, a beacon frame, a media access control (MAC) frame, an action frame, etc. According to the example of the disclosure, the first message frame may include a parameter configured to set a WLAN sensing function. An example of parameters carried in the first message frame is described later with reference to Table 1.

In the example of the disclosure, the first message frame may be determined in many ways. For example, the first message frame may be generated or configured according to at least one of the following conditions: a channel state, a network condition, a load condition, a hardware capability of a sending/receiving device, a service type, and a relevant protocol specification, which are not specifically limited in the example of the disclosure. In the example of the disclosure, the first message frame may also be obtained from an external device, which is not specifically limited in the example of the disclosure.

In step 220, the first message frame is sent. For example, the initiator may send the first message frame carrying the parameters directly to the responder, or forward the first message frame to the responder by means of an intermediate device (for example, an AP as shown in FIG. 1(c)), such that the initiator and the responder may execute the WLAN sensing function based on the carried parameters.

According to the example of the disclosure, the parameter may be defined in the setup phase of the WLAN sensing session. In other words, the communication method shown in FIG. 2 may be an operation executed in the setup phase of the WLAN sensing session. By defining the parameters in the setup phase of the WLAN sensing session, the device may implement sensing better in the following phases (for example, the measurement phase, the reporting phase, and the termination phase as described above).

According to the example of the disclosure, the parameter configured to set the WLAN sensing function may be carried in the first message frame in a form of information element, which is not limited to this. The parameter may be carried in any other feasible mode.

Table 1 is an instance showing a parameter (in the following, simply referred to as WLAN sensing parameter) configured to set a WLAN sensing function according to an example of the disclosure.

TABLE 1
Instances of WLAN sensing parameters

| | | | | | | |
|---|---|---|---|---|---|---|
| Dialog | Session | . . . | Process | Process | Number | Sensing |
| token | ID | | ID 1 | ID n | | Mode |

It can be understood that each content in Table 1 of the disclosure exists independently. These contents are illustratively listed in the same table, but it does not mean that all contents in the table must exist at the same time as shown in the table. Moreover, those skilled in the art can understand that each content and value in Table 1 of the disclosure is an independent example.

According to the example of the disclosure, the WLAN sensing parameter may include a dialog token configured to secure the WLAN sensing session, such as Dialog token in Table 1. Although only one dialog token is shown in Table 1, the disclosure is not limited to this, and two or more dialog tokens may be included depending on a security mechanism. The initiator and the receiver of the WLAN sensing session secure the WLAN sensing session by means of authentication of the dialog token.

According to the example of the disclosure, the WLAN sensing parameter may include a session identifier, such as Session ID in Table 1. The session identifier may be configured to verify a transmitted frame in a WLAN sensing session.

For example, the Session ID is an identifier (including frames sent from the WLAN sensing initiator) that the sender and receiver of WLAN sensing frames need to verify frames sent in the entire process for completing WLAN sensing within a period of time. Specifically, the Session ID may be applied as an identifier to each phase in the WLAN sensing session. For example, the Session ID may be carried in frames transmitted in each phase of the WLAN sensing session, to verify that the transmitted frames correspond to the WLAN sensing session.

Although only one session identifier is shown in Table 1, the disclosure is not limited to this. For example, WLAN sensing parameters may include identifiers (that is, Session IDs) of a plurality of sensing sessions, and each sensing session may be in a time-division mode. By including a plurality of session identifiers, the initiator or the responder may participate in a plurality of WLAN sensing sessions. That is to say, a plurality of WLAN sensing sessions can be defined in one WLAN sensing parameter, to improve WLAN sensing efficiency. For simplicity, hereafter, an example is mainly described in which the WLAN sensing parameter includes one session identifier (that is, one WLAN sensing session). It should be understood that such an example may be applied to each of a plurality of session identifiers (that is, each WLAN sensing session).

In one WLAN sensing session, the sender and the receiver may have a plurality of frame interactions, in other words, one WLAN sensing session may include at least one session process, and the initiator and the responder of the WLAN sensing session may perform an interactive operation based on the session process. To this end, according to the example of the disclosure, the WLAN sensing parameter may include at least one session process identifier, such as Process ID 1, Process ID n (n is an integer greater than or equal to 1) shown in Table 1. According to the example of the disclosure, each session process identifier may be configured to represent an interaction between a sender and a receiver of a WLAN sensing frame in a WLAN sensing session. As an instance, the WLAN sensing frame may be a null data packet (NDP) frame, a ranging frame, or other frames for WLAN sensing. The NDP frame contains a certain number of long training fields (LTFs) or short training fields (STFs).

Each session process identifier may represent one interaction (frame interaction) between the sender and receiver of the WLAN sensing frame. According to example of the disclosure, a mode of the interaction may be timely feedback or delayed feedback. The following describes the mode of the interaction by taking NDP frame as an instance.

In case that the mode of the interaction is timely feedback, the sender sends NDP frames many times, and the receiver feeds back results (feedback) many times. That is to say, each time the sender sends an NDP frame, the receiver feeds back the NDP frame.

In case that the mode of the interaction is delayed feedback, the sender sends a plurality of NDP frames once, and the receiver feeds back a result (feedback) once. That is to say, after the sender sends a plurality of NDP frames, the receiver feeds back the plurality of sent NDP frames once. For example, the feedback result may be channel state information (CSI) or received signal strength indicator (RSSI), etc.

Such an interaction of timely feedback or an interaction of delayed feedback may be referred to as a session process. In a WLAN sensing session, a session process ID needs to be defined for each session process (NDP->feedback). In the example of the disclosure, the feedback result may not be fed back to a sending frame of the WLAN sensing frame, but fed back to the initiator (the initiator may not be the sender or the receiver of the WLAN sensing frame) of the WLAN sensing session. For example, as shown in FIG. 1(c), the initiator of the WALN sensing session may be the client at the lower right side, and the sender of the WLAN sensing frame may be the AP. The feedback result of the WLAN sensing frame may be fed back to the client which is the initiator of the WALN sensing session, instead of the AP which is the sender of the WLAN sensing frame.

According to the example of the disclosure, the WLAN sensing parameter may include an identification bit, such as Number in Table 1, configured to identify the number of occurrence of the at least one session process identifier. In the example of the disclosure, the number of occurrence of the at least one session process identifier may be related to the number of the interaction or the number of sending and feeding back of the WLAN sensing frame. For example, the total number of session process identifiers is based on the number of sending of WLAN sensing frames (NDP frames or ranging frames) by the WLAN sensing session initiator (or the sender of WLAN frames) in one WLAN sensing session, or on the number of sending of WLAN sensing frames and reception of feedback by the WLAN sensing session initiator. In case that the mode of interaction is timely feedback, the number of occurrence of at least one session process identifier appears may be the number of sending of WLAN sensing frames (NDP frames or ranging frames) by the WLAN sensing session initiator (or the sender of WLAN frames) in one WLAN sensing session. In case that the mode of interaction is delayed feedback, the number of occurrence of at least one session process identifier appears may be the number of reception of feedback by the WLAN sensing session initiator.

In another example of the disclosure, an identification bit (Number) for identifying the number of occurrence of at least one session process identification may be omitted from the WLAN sensing parameters. In the example, the number of the interaction may be determined based on the number of session Process IDs (that is, the value of n).

By defining the Process ID and/or identification bit (Number) of sessions, the initiator and the responder of the WLAN sensing session can interact with each other a plurality of times with WLAN sensing frames, to better perform WLAN sensing.

According to the example of the disclosure, the WLAN sensing parameter may include an identification bit (in the following, referred to as “sensing mode identification bit”) configured to identify a WLAN sensing mode, such as Sensing Mode in Table 1.

The sensing mode identification bit may have one or more bits. Different WLAN sensing modes are identified by setting the sensing mode identification bit to different values. For example, a WLAN sensing mode identified by the sensing mode identification bit may be a channel state information (CSI) mode, a ranging mode, or a radar mode. However, the disclosure is not limited to the above modes, and other methods or modes capable of sensing are also included within the scope of the disclosure.

By setting a parameter of the sensing mode identification bit, the WLAN sensing function can be selectively implemented in different sensing modes, which increases flexibility and applicability of a system.

According to the example of the disclosure, when the WLAN sensing mode is the channel state information (CSI) mode, sending power of a device sending a WLAN sensing frame is equal in one WLAN sensing session. By setting the same sending power for the WLAN sensing frames in one WLAN sensing session, WLAN sensing can be performed according to a standard, and the WLAN sensing function can be better implemented.

It should be understood that the instances of the WLAN sensing parameters described above with reference to Table 1 are illustrative only and does not limit the disclosure. For example, the order of the various contents in Table 1 may be changed, other contents may be added, or some contents may be omitted. For example, when the parameters are carried in the first message frame in a form of information elements, the WLAN sensing parameters shown in Table 1 may further include element IDs, lengths, etc.

FIG. 3 is a flowchart of another communication method according to an example. The communication method shown in FIG. 3 may be applied to a WLAN sensing responder.

With reference to FIG. 3, in step 310, a first message frame is received. The first message frame includes a parameter (in the following, referred to as “WLAN sensing parameter”) configured to set a WLAN sensing function.

According to the example of the disclosure, the WLAN sensing parameter may include a dialog token configured to secure the WLAN sensing session.

According to the example of the disclosure, the WLAN sensing parameter may include a session identifier, and the session identifier is configured to verify a transmitted frame in a WLAN sensing session.

According to the example of the disclosure, the WLAN sensing parameter may include at least one session process identifier, and each session process identifier is configured to represent an interaction between a sender and a receiver of a WLAN sensing frame in a WLAN sensing session. For example, a mode of the interaction is timely feedback or delayed feedback.

According to the example of the disclosure, the WLAN sensing parameter may include an identification bit configured to identify the number of occurrence of the at least one session process identifier. For example, the number of occurrence of the at least one session process identifier is related to the number of the interaction or the number of sending and feeding back of the WLAN sensing frame.

According to the example of the disclosure, the WLAN sensing parameter may include an identification bit configured to identify a WLAN sensing mode. For example, the WLAN sensing mode may be, but not limited to, a channel state information mode, a ranging mode, or a radar mode.

According to the example of the disclosure, when the WLAN sensing mode is the channel state information mode, sending power of a device sending a WLAN sensing frame is equal in one WLAN sensing session.

Parameters related to at least one WLAN sensing session described above with reference to Table 1 may be applied here, and repeated descriptions are omitted here in order to avoid redundancy.

In step 320, a communication operation is executed based on the first message frame. For example, the WLAN sensing session may be executed according to the WLAN sensing parameter carried in the first message frame. For example, a plurality of WLAN frame interactions may be executed in an appropriate sensing mode according to the session process identifier, the sensing mode identification bit, etc. in the WLAN sensing parameters, so as to achieve WLAN sensing.

FIG. 4 is a block diagram of a communication apparatus according to an example. The communication apparatus 400 in FIG. 4 may include a processing module 410 and a receiving and sending module 420. In an example of the disclosure, the communication apparatus 400 shown in FIG. 4 may be applied to a WLAN sensing initiator. In another example of the disclosure, the communication apparatus 400 shown in FIG. 4 may be applied to a WLAN sensing responder.

When the communication apparatus 400 shown in FIG. 4 may be applied to a WLAN sensing initiator, the processing module 410 may be configured to determine a first message frame, where the first message frame includes a parameter configured to set a WLAN sensing function; and the receiving and sending module 420 may be configured to send the first message frame. That is, the communication apparatus 400 shown in FIG. 4 may execute the communication method described with reference to FIG. 2, the example described with reference to Table 1 may be applied to this, and repeated description is omitted here in order to avoid redundancy.

When the communication apparatus 400 shown in FIG. 4 may be applied to a WLAN sensing responder, the receiving and sending module 420 may be configured to receive a first message frame, where the first message frame includes a parameter configured to set a WLAN sensing function; and the processing module 410 may be configured to execute a communication operation according to the first message frame. That is, the communication apparatus 400 shown in FIG. 4 may execute the communication method described with reference to FIG. 3, the example described with reference to Table 1 may be applied to the communication apparatus, and repeated description is omitted here in order to avoid redundancy.

It will be appreciated that the communication apparatus 400 shown in FIG. 4 is merely illustrative, and examples of the disclosure are not limited to this. For example, the communication apparatus 400 may also include other modules such as a memory module, etc. Furthermore, the various modules in the communication apparatus 400 may be combined into more complex modules or may be divided into more individual modules.

The communication method and the communication apparatus according to the examples of the disclosure may define specific parameters of a WLAN sensing session in, for example, a setup phase of WLAN sensing, such that a device can implement sensing better. Furthermore, the device can perform WLAN sensing within a defined phase while interference to other devices is reduced.

Based on the same principles as the methods provided by the examples of the disclosure, the example of the disclosure also provides an electronic device. The electronic device includes a processor and a memory. The memory stores a machine-readable instructions (which may also be referred to as a “computer program”). The processor is configured to execute the machine-readable instructions to implement the methods described with reference to FIGS. 2 and 3.

The example of the disclosure further provides a computer-readable storage medium. The computer-readable storage medium stores a computer program. When executed by a processor, the computer program implements the methods described with reference to FIGS. 2 and 3.

In an example, the processor may be a central processing unit (CPU), a general purpose processor, a digital signal processor (DSP), an application specific integrated circuit (ASIC), a field programmable gate array (FPGA) or other programmable logic devices, transistor logic devices, hardware components, or any combination of them, to implement or execute the various illustrative logical blocks, modules, and circuits described in combination with the disclosure. A processor may also be a combination that performs computational functions, for example, a combination including one or more microprocessors, a combination of a DSP and a microprocessor, etc.

In an example, the memory may be, for example, a read only memory (RAM), a random access memory (RAM), an electrically erasable programmable read only memory (EEPROM), a compact disc read only memory (CD-ROM) or other optical disk storages, compact disk storages (including compact discs, laser discs, optical discs, digital versatile discs, Blu-ray discs, etc.), magnetic disk storage media or other magnetic storage devices, or any other medium that can be used to carry or store program code in a form of instructions or data structures and that can be accessed by a computer, but is not limited to this.

It will be understood that while various steps in the flowcharts of the drawings are shown in sequence as indicated by arrows, the steps are not necessarily executed in sequence in the order indicated by the arrows. These steps are not executed in strict order and can be executed in other orders, unless explicitly stated here. Moreover, at least some steps in the flowcharts of the drawings can include a plurality of sub-steps or stages that are not necessarily executed simultaneously but can be executed at different moments. These sub-steps or stages are not necessarily executed in order, and can be executed along with at least some other steps, sub-steps of other steps, or stages in turn or in an alternate mode.

While the disclosure has been shown and described with reference to some examples of the disclosure, it will be understood by those skilled in the art that various changes in form and details may be made without departing from the scope of the disclosure. Accordingly, the scope of the disclosure should not be limited to the examples, but rather should be defined by the appended claims and equivalents of the claims.

1. A communication method, comprising:
determining a first message frame, wherein the first message frame comprises a parameter configured to set a wireless local area network (WLAN) sensing function; and
sending the first message frame.

2. The communication method according to claim 1, wherein the parameter comprises a session identifier, and the session identifier is configured to verify a transmitted frame in a WLAN sensing session.

3. The communication method according to claim 1, wherein the parameter comprises at least one session process identifier, and each session process identifier is configured to represent an interaction between a sender and a receiver of a WLAN sensing frame in a WLAN sensing session.

4. The communication method according to claim 3, wherein a mode of the interaction is timely feedback or delayed feedback.

5. The communication method according to claim 3, wherein the parameter comprises an identification bit configured to identify a number of occurrence of the at least one session process identifier.

6. The communication method according to claim 3, wherein a number of occurrence of the at least one session process identifier is related to a number of the interaction or a number of sending and feeding back of the WLAN sensing frame.

7. The communication method according to claim 1, wherein the parameter comprises an identification bit configured to identify a WLAN sensing mode.

8. The communication method according to claim 7, wherein the WLAN sensing mode is a channel state information mode, a ranging mode, or a radar mode, and
wherein the WLAN sensing mode is determined to be the channel state information mode, and sending power of a device sending a WLAN sensing frame is equal in one WLAN sensing session.

9. (canceled)

10. The communication method according to claim 1, wherein the parameter comprises a dialog token configured to secure WLAN sensing session.

11. A communication method, comprising:
receiving a first message frame, wherein the first message frame comprises a parameter configured to set a WLAN sensing function; and
executing a communication operation based on the first message frame.

12. The communication method according to claim 11, wherein the parameter comprises a session identifier, and the session identifier is configured to verify a transmitted frame in a WLAN sensing session.

13. The communication method according to claim 11, wherein the parameter comprises at least one session process identifier, and each session process identifier is configured to represent an interaction between a sender and a receiver of a WLAN sensing frame in a WLAN sensing session.

14. The communication method according to claim 13, wherein a mode of the interaction is timely feedback or delayed feedback.

15. The communication method according to claim 14, wherein the parameter comprises an identification bit configured to identify a number of occurrence of the at least one session process identifier.

16. The communication method according to claim 13, wherein a number of occurrence of the at least one session process identifier is related to a number of the interaction or a number of sending and feeding back of the WLAN sensing frame.

17. The communication method according to claim 11, wherein the parameter comprises an identification bit configured to identify a WLAN sensing mode.

18. The communication method according to claim 17, wherein the WLAN sensing mode is a channel state information mode, a ranging mode, or a radar mode, and
wherein the WLAN sensing mode is determined to be the channel state information mode, and sending power of a device sending a WLAN sensing frame is equal in one WLAN sensing session.

19. (canceled)

20. The communication method according to claim 11, wherein the parameter comprises a dialog token configured to secure WLAN sensing session.

21. (canceled)

22. (canceled)

23. An electronic apparatus, comprising a memory, one or more processors, and a computer program stored in the memory and executable by the one or more processors, wherein execution of the computer program configures the one or more processors to:
determine a first message frame, wherein the first message frame comprises a parameter configured to set a wireless local area network (WLAN) sensing function; and send the first message frame.

24. (canceled)

25. An electronic apparatus, comprising a memory, one or more processors, and a computer program stored in the memory and executable by the one or more processors, wherein the one or more processors implement the communication method according to claim 11 when executing the computer program.
